(19) United States
(12) Patent Application Publication
(10) Pub. No.: US 2024/0362751 A1
(43) Pub. Date: Oct. 31, 2024

(54) IMAGE PROCESSING DEVICE, IMAGE PROCESSING METHOD AND LIGHT SCANNER SYSTEM

(71) Applicant: Sony Semiconductor Solutions Corporation, Atsugi-shi, Kanagawa (JP)

(72) Inventors: Serge HUSTIN, Stuttgart (DE); Martin LOVELL, Stuttgart (DE)

(73) Assignee: Sony Semiconductor Solutions Corporation, Atsugi-shi, Kanagawa (JP)

(21) Appl. No.: 18/577,296

(22) PCT Filed: Jul. 13, 2022
(86) PCT No.: PCT/EP2022/069671

§ 371 Date: Jan. 8, 2024

(30) Foreign Application Priority Data
Jul. 15, 2021 (EP) 21185878.2

(51) Int. Cl. G06T 5/50; G06T 7/10; G06V 10/143; H04N 5/74

(52) U.S. Cl. CPC G06T 5/50; G06T 7/10; G06V 10/143; H04N 5/74; G06T 2207/20221

(57) ABSTRACT

An image processing device for a light scanner system for scanning an object, including circuitry configured to: obtain first image data representing a first image of the object that is illuminated with a line of light in an illumination plane, wherein the first image is acquired at a first viewpoint; obtain second image data representing a second image of the illuminated object, wherein the second image is acquired at a second viewpoint being different from the first viewpoint; and project the first and the second image data in the illumination plane representing a projected first and second image, respectively, for merging the first and second image data in the illumination plane.

### TECHNICAL FIELD

The present disclosure generally pertains to an image processing device and an image processing method for a light scanner system for scanning an object and to a light scanner system for scanning an object.

### TECHNICAL BACKGROUND

Generally, light scanner systems for scanning an object to obtain, e.g., information about the form of the object are known. Typically, such light scanner systems are used for scanning opaque objects, e.g., for scanning a volume of objects on a conveyors belt.

For example, laser light scanner systems are known which include a laser and a camera having a predetermined positional relationship to each other. The laser illuminates the object with a light point or a line of light and the camera detects light reflected from the surface of the object. Depending on a distance to the object, the reflected light appears at different places in the image acquired with the camera such that, based on the predetermined positional relationship, the laser light scanner system can obtain information about the form of the object by triangulation.

However, the scanning of an object that is transparent for the wavelength of the laser (e.g., transparent in the visible spectrum such as a glass bottle) may be difficult with such laser light scanner systems, in some cases, as generally known, due to a low reflectivity of its surface and multiple reflections and refractions they cause which may influence a quality of the acquired image. Thus, illuminating an object that is transparent for the illumination wavelength may not allow, in some cases, to acquire a sharp and unambiguous image of the object such that, e.g., the information about the form of the object may be influenced.

Known laser light scanner systems may be used for scanning such objects, in some cases, but this may require them to be covered with powder that is opaque for the illumination wavelength.

Although there exist techniques for light scanner systems for scanning an object, it is generally desirable to improve the existing techniques.

### SUMMARY

According to a first aspect the disclosure provides an image processing device for a light scanner system for scanning an object, comprising circuitry configured to:
obtain first image data representing a first image of the object that is illuminated with a line of light in an illumination plane, wherein the first image is acquired at a first viewpoint;
obtain second image data representing a second image of the illuminated object, wherein the second image is acquired at a second viewpoint being different from the first viewpoint, and
project the first and the second image data in the illumination plane representing a projected first and second image, respectively, for merging the first and second image data in the illumination plane.

According to a second aspect the disclosure provides an image processing method for a light scanner system for scanning an object, the method comprising:
obtaining first image data representing a first image of the object that is illuminated with a line of light in an illumination plane, wherein the first image is acquired at a first viewpoint;
obtaining second image data representing a second image of the illuminated object, wherein the second image is acquired at a second viewpoint being different from the first viewpoint; and
projecting the first and the second image data in the illumination plane representing a projected first and second image, respectively, for merging the first and second image data in the illumination plane.

According to a third aspect the disclosure provides a light scanner system for scanning an object, comprising:
a light source configured to illuminate an object with a line of light in an illumination plane;
a first camera positioned at a first viewpoint configured to acquire a first image of the illuminated object;
a second camera positioned at a second viewpoint being different from the first viewpoint configured to acquire a second image of the illuminated object; and
an image processing device including circuitry configured to:
   obtain first image data representing the first image,
   obtain second image data representing the second image, and
   project the first and the second image data in the illumination plane representing a projected first and second image, respectively, for merging the first and second image data in the illumination plane.

Further aspects are set forth in the dependent claims, the following description and the drawings.

### BRIEF DESCRIPTION OF THE DRAWINGS

Embodiments are explained byway of example with respect to the accompanying drawings, in which:

FIG. 1 schematically illustrates an embodiment of a light scanner system for scanning an object,

FIG. 2 schematically illustrates in FIG. 2A and in FIG. 2B a principle of image data projection based on a pinhole camera model; and

FIG. 3 schematically illustrates in a flow diagram an embodiment of an image processing method.

### DETAILED DESCRIPTION OF EMBODIMENTS

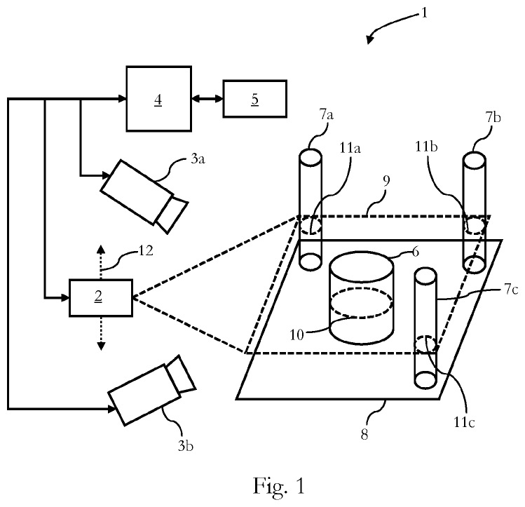

Before a detailed description of the embodiments under reference of FIG. 1 is given, general explanations are made.

As mentioned in the outset, the scanning of an object that is transparent for the wavelength of the laser (e.g., transparent in the visible spectrum such as a glass bottle) may be difficult with known laser light scanner systems, in some cases, as generally known, due to a low reflectivity of its surface and multiple reflections and refractions they cause within the object and its surroundings which may influence a quality of the acquired image. Thus, illuminating an object that is transparent for the illumination wavelength may typically not allow to acquire a sharp and unambiguous image of the object such that, e.g., the information about the form of the object may be influenced.

It has been recognized that at least two images of an illuminated object—that is transparent for the illumination wavelength—should be acquired from at least two different viewpoints for reducing an influence of the multiple reflections and refractions within the object on the image quality.

Moreover, it has been recognized that, for reducing an influence of the weak reflection on the image quality, the at least two images should be merged for enhancing an imaging contrast for improving the image quality.

Hence, some embodiments pertain to an image processing device for a light scanner system for scanning an object, wherein the image processing device includes circuitry configured to:
obtain first image data representing a first image of the object that is illuminated with a line of light in an illumination plane, wherein the first image is acquired at a first viewpoint;
obtain second image data representing a second image of the illuminated object, wherein the second image is acquired at a second viewpoint being different from the first viewpoint, and
project the first and the second image data in the illumination plane representing a projected first and second image, respectively, for merging the first and second image data in the illumination plane.

The circuitry may be based on or may include or may be implemented as integrated circuitry logic or may be implemented by a CPU (central processing unit), an application processor, a graphical processing unit (GPU), a microcontroller, an FPGA (field programmable gate array), an ASIC (application specific integrated circuit) or the like. The functionality may be implemented by software executed by a processor such as an application processor or the like. The circuitry may be based on or may include or may be implemented by typical electronic components configured to achieve the functionality as described herein. The circuitry may be based on or may include or may be implemented in parts by typical electronic components and integrated circuitry logic and in parts by software.

The circuitry may include a communication interface configured to communicate and exchange data with a computer or processor (e.g. an application processor or the like) over a network (e.g. the internet) via a wired or a wireless connection such as WiFi®, Bluetooth® or a mobile telecommunications system which may be based on UMTS, LTE or the like (and implements corresponding communication protocols). The circuitry may include a data bus (interface) (e.g. a Camera Serial Interface (CSI) in accordance with MIPI (Mobile Industry Processor Interface) specifications (e.g. MIPII CSI-2 or the like) or the like). The circuitry may include the data bus (interface) for transmitting (and receiving) data over the data bus.

The circuitry may include data storage capabilities to store data such as memory which may be based on semiconductor storage technology (e.g. RAM, EPROM, etc.) or magnetic storage technology (e.g. a hard disk drive) or the like.

Some embodiments pertain to a light scanner system for scanning an object, wherein the light scanner system includes:
a light source configured to illuminate an object with a line of light in an illumination plane;
a first camera positioned at a first viewpoint configured to acquire a first image of the illuminated object;
a second camera positioned at a second viewpoint being different from the first viewpoint configured to acquire a second image of the illuminated object; and
an image processing device including circuitry configured to:
   obtain first image data representing the first image,
   obtain second image data representing the second image, and
   project the first and the second image data in the illumination plane representing a projected first and second image, respectively, for merging the first and second image data in the illumination plane.

The light source may be, for example, a laser such as a laser diode or the like, a laser array such as a laser diode array or the like, a light emitting diode, a light emitting diode array or the like. The light source may include optical parts such as lenses, mirrors, one or more optical filters (e.g., an optical (narrow) bandpass filter, a polarization filter or the like), etc.

The light source is configured to illuminate the object with the line of light in the illumination plane, wherein the line of light may be characterized by a spatial intensity distribution which is much narrower above and below the illumination plane.

The light source may emit polarized light (e.g., linear or circular polarized light) such that the line of light may be a polarized line of light.

The line of light may have a center wavelength (of a spectral light emission profile of the light source), for example, in the visible spectrum or in the infrared spectrum without limiting the disclosure in this regard. The center wavelength may also be referred to as the illumination wavelength.

The object may be transparent, for example, in the visible or in the infrared spectrum or the like. The object may be transparent with respect to the center wavelength of light emitted by the light source. Hence, in some embodiments, the object is a transparent object. The object may be opaque, for example, in the visible or in the infrared spectrum or the like. The object may be opaque with respect to the center wavelength of light emitted by the light source. Hence, in some embodiments, the object is an opaque object. A part of the object may be transparent, and another part of the object may be opaque.

The scanning of the object is typically the movement of the line of light along the object, for example, the light source may be moved in predetermined steps in a predetermined scanning direction with respect to the object or the object may be moved with respect to the light source for scanning the object.

The illumination plane basically defines an illumination coordinate system. The illumination coordinate system may move in predetermined steps along the predetermined scanning direction when the object is scanned.

The first and the second viewpoint may be predetermined or may be determined in a calibration procedure based on reference objects in the illumination plane. A viewpoint includes a position and an orientation of a camera with respect to the illumination coordinate system.

In some embodiments, the first image is acquired by a camera positioned at the first viewpoint and the second image is acquired by the camera moved from the first viewpoint to the second viewpoint.

In such embodiments, the first and the second image is acquired by a single camera that is moved from the first viewpoint to the second viewpoint.

In some embodiments, the first image is acquired by a first camera positioned at the first viewpoint and the second image is acquired by a second camera positioned at the second viewpoint. In such embodiments, the first and the second image are acquired by two different cameras positioned at different viewpoints.

Each of the camera, the first and the second camera may be a RGB (“red-green-blue”) camera, an infrared camera or the like which include an image sensor having a plurality of image pixels configured to detect light. Each of the camera, the first and the second camera or the image sensor may include one or more optical filters such as an optical long pass filter, an optical short pass filter, an optical (narrow) bandpass filter or the like. The optical filter, for example, the (narrow) bandpass filter may be aligned on or may be adapted to the center wavelength of the spectral emission profile of the light source, e.g., for blocking at least a part of ambient light. The one or more optical filters may include a polarization filter. The polarization filter may be adapted to a polarization of the line of light emitted by the light source, e.g., for blocking at least a part of ambient light.

The image sensor is configured to generate image data in response to the light detection by the plurality of image pixels for acquiring an image of the illuminated object.

The image data include a plurality of pixel values from the plurality of image pixels representing the image of the illuminated object and, thus, a pixel value of the plurality of pixel values is associated with an image pixel of the plurality of image pixels (and thus an image pixel position). The pixel values may be, for example, RGB values, CYMK values, or gray values (for example, values between 0 and 255 or the like).

As mentioned above, by acquiring images of the object—e.g., an object that is transparent for the illumination wavelength—from different viewpoints, an influence of the multiple reflections and refractions within the object on the image quality may be reduced. Moreover, a form of an object may be determined more reliably, since occlusions may be reduced, for example, for opaque parts of the object (e.g., opaque for the illumination wavelength).

The first and the second image data are projected in the illumination plane representing a projected first and second image, respectively, for merging the first and second image data in the illumination plane.

Basically, projecting image data in the illumination plane includes an association of the plurality of pixel values from the plurality of image pixels with parts of the illumination plane, in other words, with coordinates in the illumination coordinate system.

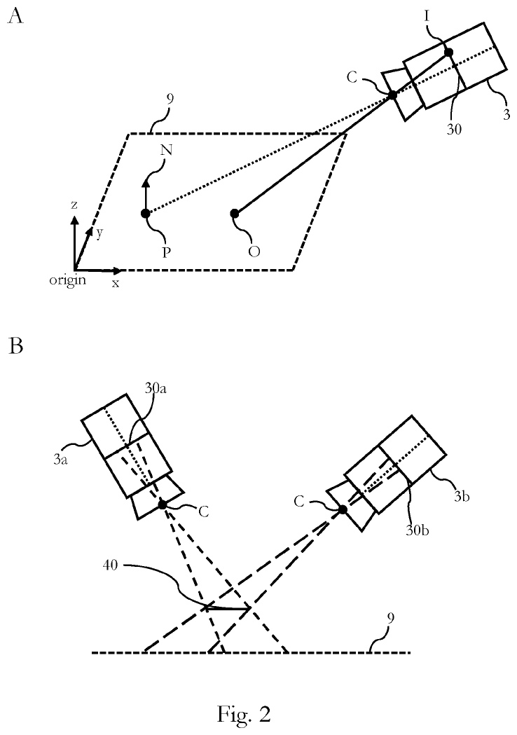

For illustration, in a simple pinhole camera model (which will be discussed also under reference of FIG. 2), a pixel value, which is associated with an image pixel in the camera (and thus an image pixel position), is projected in the illumination plane based on the camera's viewpoint and a homogeneous dilation (“centric stretching”) with respect to a center given by the pinhole. Thereby, the plurality of pixel values from the plurality of image pixels is associated with coordinates in the illumination coordinate system.

Thus, the projected first image data include a plurality of first pixel values, wherein a pixel value of the plurality of first pixel values, which is generated in response to the detection of light that originates from a point which lies in the illumination plane, is associated with coordinates of that point in the illumination plane.

Thus, the projected second image data include a plurality of second pixel values, wherein a pixel value of the plurality of second pixel values, which is generated in response to the detection of light that originates from a point which lies in the illumination plane, is associated with coordinates of that point in the illumination plane.

Therefore, due to the projection of the first and second image data in the illumination plane, first coordinates associated with first pixel values of the plurality of first pixel values, which are generated in response to the detection of light that originates from points which lie in the illumination plane, are the same as second coordinates associated with second pixel values of the plurality of second pixel values, which are generated in response to the detection of light that originates from the same points which lie in the illumination plane.

Hence, identical parts in the projected first and second image are determined by the same coordinates in the illumination plane associated with the first and second pixel values such that the first and second image data can be merged in the illumination plane based on the first pixel values and the second pixel values associated with these coordinates.

In other words, the images acquired at the different viewpoints (e.g., acquired by two cameras) are merged by computing the projections of the different images in the illumination plane of the light source, and by looking for the parts in the projected different images that appear at the same position. Typically, only the points of the object or its surrounding that are in the illumination plane of the light source appear at the same position in the two images, whereas the parts of the object or its surrounding that are away from the illumination plane do not match.

Thus, in some embodiments, the circuitry is further configured to merge the first and the second image data in the illumination plane representing a merged image.

In some embodiments, the circuitry is further configured to merge the first and the second image data in the illumination plane representing a merged image by calculating a product of the projected first and the second image data for identical parts in the projected first and second image.

In such embodiments, a first pixel value of the first pixel values of the plurality of first pixel values is multiplied with a second pixel value of the second pixel values of the plurality of second pixel values when the first pixel value and the second pixel value are associated with the same coordinates in the illumination plane.

In such embodiments, the merged image is represented by such pixel value products.

Thereby, an image quality of an image of the object—e.g., an object that is transparent for the illumination wavelength—may be enhanced, since, on the one hand, images of the object from different viewpoints can be merged for reducing an influence of the multiple reflections and refractions within the object on the image quality and, on the other hand, an image contrast may be enhanced.

Assuming, for example, the first image acquired at the first viewpoint has a noisy region of a cross-section of the object and the second image acquired at the second viewpoint has less noise in the region of the cross-section of the object. Then the image contrast may be enhanced by calculating the product of the pixel values in this region, since high intensity regions are enhanced and low intensity regions are suppressed.

In other embodiments, the first and the second image data are merged in the illumination plane representing a merged image by calculating a ratio or a difference between the projected first and the second image data for identical parts in the projected first and second image.

As mentioned above, the projection of image data in the illumination plane is based on the viewpoint of the camera, since it defines a position and orientation of the camera with respect to the illumination coordinate system.

As further mentioned above, the first and the second viewpoint may be predetermined or may be determined in a calibration procedure based on reference objects in the illumination plane.

Hence, in some embodiments, the circuitry is further configured to calibrate the projection of the first and the second image data in the illumination plane based on a plurality of reference objects in the illumination plane.

Generally, the merged image may be used for determining a form of the object by scanning the object with the line of light and determining a cross-section of the object for each scanning position based on the merged image. The determined form of the object may be used for generating a three-dimensional computer model of the object. The merged image may be used for material identification of the object, since a shape of a curve or a closed loop representing the cross-section in the merged image may depend on the material of the object due to material-based reflection and scattering properties.

Thus, in some embodiments, the circuitry is further configured to perform image segmentation on the merged image for determining a cross-section of the object in the illumination plane.

In some embodiments, image segmentation is performed based on a set of predetermined cross-section criteria. The predetermined set of cross-section criteria may be, for example, a curve or a closed loop, a shape and thickness of the curve or the closed loop, an appearance of curve or the closed loop in a predetermined region of the merged image, etc.

In some embodiments, the object is further illuminated with a second line of light in the illumination plane or in a second illumination plane different from the illumination plane. For example, for avoiding or reducing obstructed areas.

Hence, in some embodiments, the light scanner system further includes a second light source configured to illuminate the object with a second line of light in the illumination plane or in a second illumination plane different from the illumination plane.

In some embodiments, the second line of light has a center wavelength different from a center wavelength of the line of light. For example, the reflection and scattering properties of the object—e.g., an object that is transparent for the illumination wavelength—may depend on the wavelength of the illumination light such that the merged image may be used for material identification when suitable different wavelengths are selected.

In some embodiments, when different center wavelengths are used by the two light sources, the line of light illuminates the object in the illumination plane and the second line of light illuminates the object in a second illumination plane different from the illumination plane.

Generally, the present disclosure is not limited to two (different) light sources or any specific number of light sources. In some embodiments, a plurality of light sources illuminates the object in a plurality of illumination planes. The plurality of illumination planes may be co-planar or may be different illumination planes.

Generally, the present disclosure is not limited to acquiring, projecting and merging only two images. Hence, in some embodiments, a plurality of images is acquired at a plurality of different viewpoints. The plurality of images may be acquired by a plurality of cameras or may be acquired by a single camera that is moved to each of the plurality of different viewpoints.

As mentioned above, the merging of the first and second image data in the illumination plane may improve an image quality, for example, by enhancing an image contrast and, thus, any additional image may further improve the image quality.

Hence, in some embodiments, the circuitry is further configured to:
obtain third image data representing a third image of the illuminated object, wherein the third image is acquired at a third viewpoint being different from the first and the second viewpoint; and
project the third image data in the illumination plane representing a projected third image for merging the first, second and third image data in the illumination plane.

Some embodiments pertain to an image processing method for a light scanner system for scanning an object, wherein the method includes:
obtaining first image data representing a first image of the object that is illuminated with a line of light in an illumination plane, wherein the first image is acquired at a first viewpoint;
obtaining second image data representing a second image of the illuminated object, wherein the second image is acquired at a second viewpoint being different from the first viewpoint; and
projecting the first and the second image data in the illumination plane representing a projected first and second image, respectively, for merging the first and second image data in the illumination plane.

The image processing method may be performed by the image processing device as described herein.

The methods as described herein are also implemented in some embodiments as a computer program causing a computer and/or a processor to perform the method, when being carried out on the computer and/or processor. In some embodiments, also a non-transitory computer-readable recording medium is provided that stores therein a computer program product, which, when executed by a processor, such as the processor described above, causes the methods described herein to be performed.

Returning to FIG. 1, there is schematically illustrated an embodiment of a light scanner system 1 for scanning an object 6, which is discussed in the following.

The light scanner system 1 includes a light source 2, a first camera 3a, a second camera 3b, a control 4 and an image processing device 5. Here, the image processing device 5 is shown as a separate device, however, in other embodiments, the image processing device 5 is part of the control 4.

The object 6 and a plurality of reference objects 7a, 7b and 7c are arranged on a table 8. The object 6 is, for example, a hollow glass jar. The plurality of reference objects 7a, 7b and 7c may be opaque objects. The plurality of reference objects 7a, 7b and 7c have predetermined positions and orientations on the table 8 which are known to the control 4 and the image processing device 5.

The light source 2 illuminates the object 6 with a line of light in an illumination plane 9 such that a cross-section 10 of the object 6 in the illumination plane 9 reflects, refracts and scatters the illumination light. The light source 2 is a laser diode. The line of light has a center wavelength in the visible spectrum. The object 6 is transparent for the illumination wavelength of the light source 2 (transparent in the visible spectrum).

Further, the light source 2 illuminates the plurality of reference objects 7a, 7b and 7c in the illumination plane 9 such that surface reflections 11a, 11b and 11c are visible on the plurality of reference objects 7a, 7b and 7c in the illumination plane 9.

Moreover, the light source 2 can be moved in a scanning direction 12 for scanning the object 6 with the line of light.

The first camera 3a is positioned at a first viewpoint and acquires a first image of the illuminated object 6. The first camera is an RGB camera.

The second camera 3b is positioned at a second viewpoint, which is different from the first viewpoint, and acquires a second image of the illuminated object 6. The second camera is an RGB camera.

The control 4 basically controls the overall operation of the light scanner system 1 such as, for example, the light emission of the light source 2, the image acquisition of the first camera 3a and the second camera 3b, the controlling of image data transfer between the cameras 3a and 3b and the image processing device 5 and the scanning of the object 6 along the scanning direction 12.

The image processing device 5 obtains first image data representing the first image of the illuminated object 6 acquired at the first viewpoint and second image data representing the second image of the illuminated object 6 acquired at the second viewpoint.

The first image data include a plurality of first pixel values from a plurality of image pixels of an image sensor in the first camera 3a. The plurality of first pixel values represents the first image of the illuminated object 6. The plurality of first pixel values includes first pixel values which are generated in response to the detection of light that originates from points which lie in the illumination plane 9, for example, from the cross-section 10 of the object 6.

The second image data include a plurality of second pixel values from a plurality of image pixels of an image sensor in the second camera 3b. The plurality of second pixel values represents the second image of the illuminated object 6. The plurality of second pixel values includes second pixel values which are generated in response to the detection of light that originates from points which lie in the illumination plane 9, for example, from the cross-section 10 of the object 6.

The illumination plane 9 defines an illumination coordinate system and the first and the second viewpoint include a position and an orientation of the first and the second camera 3a and 3b, respectively, with respect to the illumination coordinate system.

The light source 2 has predetermined scanning positions along the scanning direction 12 which are known to the control 4 and the image processing device 5. Moreover, the light source 2 has a predetermined orientation with respect to the table 8 such that the orientation of the illumination plane 9 with respect to the table 8 is known to the control 4 and the image processing device 5.

The image processing device 5 determines the first viewpoint and the second viewpoint based on the positions and orientations of the surface reflections 11a, 11b and 11c on the plurality of reference objects 7a, 7b and 7c in the first and second image, respectively.

Hence, the image processing device 5 calibrates a projection of the first and the second image data in the illumination plane based on the plurality of reference objects 7a, 7b and 7c.

The image processing device 5 projects the first and the second image data in the illumination plane 9 representing a projected first and second image, respectively, for merging the first and second image data in the illumination plane 9.

Due to the projection of the first and second image data in the illumination plane 9, the first pixel values and the second pixel values are associated with coordinates in the illumination plane 9 with respect to the illumination coordinate system.

The image processing device 5 merges the first and the second image data in the illumination plane 9 representing a merged image by calculating a product of the projected first and second image data for identical parts in the projected first and second image.

The identical parts in the projected first and second image are determined by the same coordinates in the illumination plane 9 associated with the first and the second pixel values.

Thus, in the calculation of the product of the projected first and second image data for identical parts in the projected first and second image, each first pixel value of the first pixel values of the plurality of first pixel values is multiplied with a second pixel value of the second pixel values of the plurality of second pixel values when the first pixel value and the second pixel value are associated with the same coordinates in the illumination plane 9.

Thereby, an image quality of an image of the object 6 may be enhanced, since, on the one hand, images of the object 6 from different viewpoints are merged for reducing an influence of multiple reflections and refractions within the object 6 on the image quality and, on the other hand, an image contrast may be enhanced.

Thus, the cross-section 10 may be determined more accurately and, moreover, the form of the object 6 may be determined more accurately when the object 6 is scanned for a plurality of scanning positions along the scanning direction 12.

The image processing device 5 performs image segmentation on the merged image for determining the cross-section 10 of the object 6, wherein the image segmentation is performed based on a set of predetermined cross-section criteria.

In other embodiments, there is only one camera which is moved from the first viewpoint to the second viewpoint for acquiring the first and the second image.

In other embodiments, there is a second light source for illuminating the object 6 with a second line of light in the illumination plane 9. The second line of light may have a center wavelength different from the center wavelength of the line of light from the light source 2.

FIG. 2 schematically illustrates in FIG. 2A and in FIG. 2B a principle of image data projection based on a pinhole camera model, which is discussed in the following.

In FIG. 2A the illumination plane 9 of FIG. 1 is shown in which an illumination coordinate system (x, y, z) in an origin is drawn in.

A camera 3 (e.g., the first camera 3a or the second camera 3b of FIG. 1) is shown which includes an image sensor 30. The camera 3 is modeled for illustration as a pinhole camera with a pinhole C through which light enters the camera 3.

The camera 3 is positioned at a viewpoint, wherein the viewpoint is determined by the position pinhole C with respect to the illumination coordinate system and an orientation of the camera 3 with respect to the illumination coordinate system.

The orientation of the camera 3 is illustrated by the dotted line which is a center line of the camera 3 through the pinhole C. The orientation of the camera 3 determines a point P (having coordinates with respect to the illumination coordinate system) in the illumination plane 9.

An image pixel position I is associated with an object point O (having coordinates with respect to the illumination coordinate system) in the illumination plane 9, as illustrated by the solid line.

Thus, a pixel value of an image pixel at the image pixel position I is associated with the object point O. In other words, the pixel value of the image pixel at the image pixel position I is associated with the coordinates of the object point O in the illumination coordinate system. The pixel value is generated in response to the detection of light that originates from the object point O in the illumination plane 9.

The association is determined by an intersection of the solid line and the illumination plane 9. The direction of the solid line determined by the direction between the image pixel position I and the pinhole C.

The projection of the image pixel position I in the illumination plane 9 is based on a homogeneous dilation (“centric stretching”) with respect to the pinhole C.

Thus, the vector to the object point O is given by:

$$\vec{O} = \vec{C} + ( \vec{C} - \vec{I} ) \cdot \frac{( \vec{C} - \vec{P} ) \cdot \vec{N}}{( \vec{I} - \vec{C} ) \cdot \vec{N}} ,$$

wherein \vec{O} is the vector from the origin of the illumination coordinate system to the object point O, \vec{C} is the vector from the origin of the illumination coordinate system to the pinhole C, \vec{I} is the vector from the origin of the illumination coordinate system to the image pixel position I, \vec{P} is the vector from the origin of the illumination coordinate system to the point P, and \vec{N} is a normal vector of the illumination plane 9.

In FIG. 2B an object 40 is shown that emits light is positioned above the illumination plane 9.

The first camera 3a and the second camera 3b acquire an first and a second image, respectively, wherein light originating from the object 40 reaches a first image sensor 30a of the first camera 3a and a second image sensor 30b of the second camera 3b, as illustrated by the short dashed line and the long dashed line, respectively.

The extension of the short dashed line and the long dashed line towards the illumination plane 9, respectively, illustrates that a first pixel value from the first image sensor 30a and a second pixel value from the second image sensor 30b, which are generated in response to light that originates from one point of the object 40 (that is positioned above (or below in other embodiments)), are typically associated with different coordinates in the illumination plane 9 when projected in the illumination plane 9.

Hence, typically, an image contrast enhancement may be selectively achieved for points in the illumination plane 9.

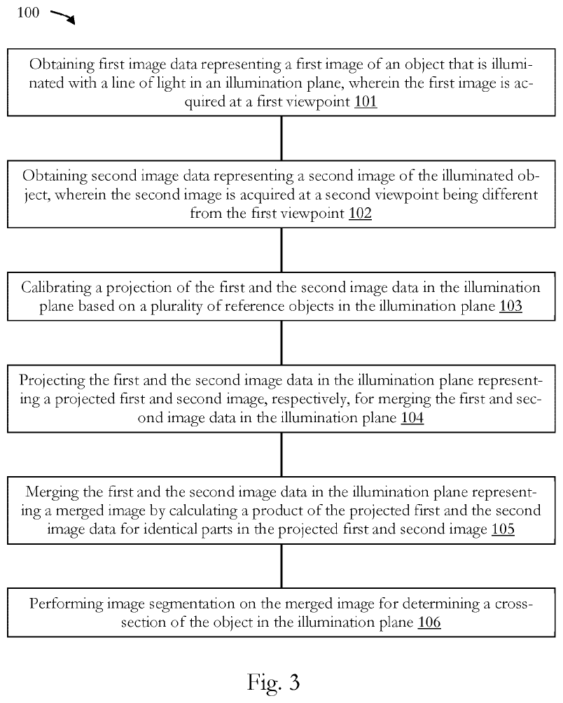

FIG. 3 schematically illustrates in a flow diagram an embodiment of an image processing method 100, which is discussed in the following.

At 101, first image data representing a first image of an object is obtained that is illuminated with a line of light in an illumination plane, wherein the first image is acquired at a first viewpoint, as discussed herein.

At 102, second image data representing a second image of the illuminated object is obtained, wherein the second image is acquired at a second viewpoint being different from the first viewpoint, as discussed herein.

At 103, a projection of the first and the second image data in the illumination plane is calibrated based on a plurality of reference objects in the illumination plane, as discussed herein.

At 104, the first and the second image data are projected in the illumination plane representing a projected first and second image, respectively, for merging the first and second image data in the illumination plane, as discussed herein.

At 105, the first and the second image data are merged in the illumination plane representing a merged image by calculating a product of the projected first and the second image data for identical parts in the projected first and second image, as discussed herein.

At 106, image segmentation is performed on the merged image for determining a cross-section of the object in the illumination plane, as discussed herein.

It should be recognized that the embodiments describe methods with an exemplary ordering of method steps. The specific ordering of method steps is however given for illustrative purposes only and should not be construed as binding.

All units and entities described in this specification and claimed in the appended claims can, if not stated otherwise, be implemented as integrated circuit logic, for example on a chip, and functionality provided by such units and entities can, if not stated otherwise, be implemented by software.

In so far as the embodiments of the disclosure described above are implemented, at least in part, using software-controlled data processing apparatus, it will be appreciated that a computer program providing such software control and a transmission, storage or other medium by which such a computer program is provided are envisaged as aspects of the present disclosure.

Note that the present technology can also be configured as described below.
(1) An image processing device for a light scanner system for scanning an object, including circuitry configured to:
   obtain first image data representing a first image of the object that is illuminated with a line of light in an illumination plane, wherein the first image is acquired at a first viewpoint;
   obtain second image data representing a second image of the illuminated object, wherein the second image is acquired at a second viewpoint being different from the first viewpoint, and
   project the first and the second image data in the illumination plane representing a projected first and second image, respectively, for merging the first and second image data in the illumination plane.
(2) The image processing device of (1), wherein the circuitry is further configured to merge the first and the second image data in the illumination plane representing a merged image by calculating a product of the projected first and the second image data for identical parts in the projected first and second image.
(3) The image processing device of (1) or (2), wherein the circuitry is further configured to calibrate the projection of the first and the second image data in the illumination plane based on a plurality of reference objects in the illumination plane.
(4) The image processing device of anyone of (1) to (3), wherein the first image is acquired by a first camera positioned at the first viewpoint and the second image is acquired by a second camera positioned at the second viewpoint.
(5) The image processing device of anyone of (1) to (4), wherein the first image is acquired by a camera positioned at the first viewpoint and the second image is acquired by the camera moved from the first viewpoint to the second viewpoint.
(6) The image processing device of anyone of (2) to (5), wherein the circuitry is further configured to perform image segmentation on the merged image for determining a cross-section of the object in the illumination plane.
(7) The image processing device of (6), wherein image segmentation is performed based on a set of predetermined cross-section criteria.
(8) The image processing device of anyone of (1) to (7), wherein the object is further illuminated with a second line of light in the illumination plane or in a second illumination plane different from the illumination plane.
(9) The image processing device of (8), wherein the second line of light has a center wavelength different from a center wavelength of the line of light.
(10) The image processing device of anyone of (1) to (9), wherein the circuitry is further configured to:
   obtain third image data representing a third image of the illuminated object, wherein the third image is acquired at a third viewpoint being different from the first and the second viewpoint, and
   project the third image data in the illumination plane representing a projected third image for merging the first, second and third image data in the illumination plane.
(11) An image processing method for a light scanner system for scanning an object, the method including:
   obtaining first image data representing a first image of the object that is illuminated with a line of light in an illumination plane, wherein the first image is acquired at a first viewpoint,
   obtaining second image data representing a second image of the illuminated object, wherein the second image is acquired at a second viewpoint being different from the first viewpoint; and
   projecting the first and the second image data in the illumination plane representing a projected first and second image, respectively, for merging the first and second image data in the illumination plane.
(12) The image processing method of (11), further including
   merging the first and the second image data in the illumination plane representing a merged image by calculating a product of the projected first and the second image data for identical parts in the projected first and second image.
(13) The image processing method of (11) or (12), further including:
   calibrating the projection of the first and the second image data in the illumination plane based on a plurality of reference objects in the illumination plane.
(14) The image processing method of anyone of (11) to (13), wherein the first image is acquired by a first camera positioned at the first viewpoint and the second image is acquired by a second camera positioned at the second viewpoint.
(15) The image processing method of anyone of (11) to (14), wherein the first image is acquired by a camera positioned at the first viewpoint and the second image is acquired by the camera moved from the first viewpoint to the second viewpoint.
(16) The image processing method of anyone of (12) to (15), further including-performing image segmentation on the merged image for determining a cross-section of the object in the illumination plane.
(17) The image processing method of (16), wherein image segmentation is performed based on a set of predetermined cross-section criteria.
(18) A light scanner system for scanning an object, including:
   a light source configured to illuminate an object with a line of light in an illumination plane;
   a first camera positioned at a first viewpoint configured to acquire a first image of the illuminated object;
   a second camera positioned at a second viewpoint being different from the first viewpoint configured to acquire a second image of the illuminated object; and
   an image processing device including circuitry configured to:
      obtain first image data representing the first image,
      obtain second image data representing the second image, and
      project the first and the second image data in the illumination plane representing a projected first and second image, respectively, for merging the first and second image data in the illumination plane.
(19) The light scanner system of (18), further including a second light source configured to illuminate the object with a second line of light in the illumination plane or in a second illumination plane different from the illumination plane.
(20) The light scanner system of (19), wherein the second line of light has a center wavelength different from a center wavelength of the line of light.
(21) A computer program comprising program code causing a computer to perform the method according to anyone of (11) to (17), when being carried out on a computer.
(22) A non-transitory computer-readable recording medium that stores therein a computer program product, which, when executed by a processor, causes the method according to anyone of (11) to (17) to be performed.

1. An image processing device for a light scanner system for scanning an object, comprising circuitry configured to:
obtain first image data representing a first image of the object that is illuminated with a line of light in an illumination plane, wherein the first image is acquired at a first viewpoint;
obtain second image data representing a second image of the illuminated object, wherein the second image is acquired at a second viewpoint being different from the first viewpoint; and
project the first and the second image data in the illumination plane representing a projected first and second image, respectively, for merging the first and second image data in the illumination plane.

2. The image processing device according to claim 1, wherein the circuitry is further configured to merge the first and the second image data in the illumination plane representing a merged image by calculating a product of the projected first and the second image data for identical parts in the projected first and second image.

3. The image processing device according to claim 1, wherein the circuitry is further configured to calibrate the projection of the first and the second image data in the illumination plane based on a plurality of reference objects in the illumination plane.

4. The image processing device according to claim 1, wherein the first image is acquired by a first camera positioned at the first viewpoint and the second image is acquired by a second camera positioned at the second viewpoint.

5. The image processing device according to claim 1, wherein the first image is acquired by a camera positioned at the first viewpoint and the second image is acquired by the camera moved from the first viewpoint to the second viewpoint.

6. The image processing device according to claim 2, wherein the circuitry is further configured to perform image segmentation on the merged image for determining a cross-section of the object in the illumination plane.

7. The image processing device according to claim 6, wherein image segmentation is performed based on a set of predetermined cross-section criteria.

8. The image processing device according to claim 1, wherein the object is further illuminated with a second line of light in the illumination plane or in a second illumination plane different from the illumination plane.

9. The image processing device according to claim 8, wherein the second line of light has a center wavelength different from a center wavelength of the line of light.

10. The image processing device according to claim 1, wherein the circuitry is further configured to:
obtain third image data representing a third image of the illuminated object, wherein the third image is acquired at a third viewpoint being different from the first and the second viewpoint; and
project the third image data in the illumination plane representing a projected third image for merging the first, second and third image data in the illumination plane.

11. An image processing method for a light scanner system for scanning an object, the method comprising:
obtaining first image data representing a first image of the object that is illuminated with a line of light in an illumination plane, wherein the first image is acquired at a first viewpoint;
obtaining second image data representing a second image of the illuminated object, wherein the second image is acquired at a second viewpoint being different from the first viewpoint; and
projecting the first and the second image data in the illumination plane representing a projected first and second image, respectively, for merging the first and second image data in the illumination plane.

12. The image processing method according to claim 11, further comprising:
merging the first and the second image data in the illumination plane representing a merged image by calculating a product of the projected first and the second image data for identical parts in the projected first and second image.

13. The image processing method according to claim 11, further comprising:
calibrating the projection of the first and the second image data in the illumination plane based on a plurality of reference objects in the illumination plane.

14. The image processing method according to claim 11, wherein the first image is acquired by a first camera positioned at the first viewpoint and the second image is acquired by a second camera positioned at the second viewpoint.

15. The image processing method according to claim 11, wherein the first image is acquired by a camera positioned at the first viewpoint and the second image is acquired by the camera moved from the first viewpoint to the second viewpoint.

16. The image processing method according to claim 12, further comprising:
performing image segmentation on the merged image for determining a cross-section of the object in the illumination plane.

17. The image processing method according to claim 16, wherein image segmentation is performed based on a set of predetermined cross-section criteria.

18. A light scanner system for scanning an object, comprising:
a light source configured to illuminate an object with a line of light in an illumination plane;
a first camera positioned at a first viewpoint configured to acquire a first image of the illuminated object,
a second camera positioned at a second viewpoint being different from the first viewpoint configured to acquire a second image of the illuminated object, and
an image processing device including circuitry configured to:
obtain first image data representing the first image,
obtain second image data representing the second image, and
project the first and the second image data in the illumination plane representing a projected first and second image, respectively, for merging the first and second image data in the illumination plane.

19. The light scanner system according to claim 18, further comprising a second light source configured to illuminate the object with a second line of light in the illumination plane or in a second illumination plane different from the illumination plane.

20. The light scanner system according to claim 19, wherein the second line of light has a center wavelength different from a center wavelength of the line of light.
